(19) United States
(12) Patent Application Publication
(10) Pub. No.: US 2012/0324665 A1
(43) Pub. Date: Dec. 27, 2012

(54) Implement for engaging planar surfaces while effecting translation movements on those surfaces

(76) Inventor: Steeven Miller, Vancouver (CA)

(21) Appl. No.: 13/134,987

(22) Filed: Jun. 23, 2011

(51) Int. Cl. B25G 1/06; A47L 1/06

(52) U.S. Cl. 15/144.1; 15/143.1

(57) ABSTRACT

The implement has a head interconnected to a handle. The head has a projecting insertion element which extends backwardly. The handle includes a front and back zones; longitudinal axis of the front zone intersects longitudinal axis of the back zone. The front zone incorporates an internally engaging, frontally open channel, which complementarily conform to the shape and size of the projection insertion element, so as to admit and snugly capture the projection insertion element. The head has a front end portion for engaging and detachably securing a working tool, for example, a wiping blade for window cleaning or a paint brush. The projecting insertion element has the shape of a spindle, a shape similar to a truncated cone or is cylindrical. The internally engaging, frontally open channel is adaptable to fit to the projecting insertion element.

### I. BACKGROUND OF THE INVENTION

1. Definition of the Invention

The present invention refers, in general, to window washing and like devices and, more particularly, to an implement for engaging planar surfaces while effecting translation movements on those surfaces.

2. Description of the State of Art

Window cleaners are usually contracted and endeavor to perform the cleaning process in a rapid manner. Working tools usually require release, replace and securement and, thus, it is important for those operations that the tools are so devised that they require minimal dexterity and physical challenge.

It has been found that the wiping blades (squeegees) will most effectively wipe a surface clean if they are maintained at an optimal angle relative to the working surface. Failure to swipe the surface at an optimal angle will lead to streaking and visibly unsatisfactory results. In order to comfortably handle the squeegee and maintain the wiping blade at a convenient angle, squeegees are typically constructed with the blade mounted at only one pre-established angle relative to the handle.

Attempts have being made to solve the foregoing expectation and requirement.

For example, U.S. Pat. No. 7,000,282, granted Feb. 21, 2006 to Cox, et al. for a “Spring-biased pivoting squeegee” describes a tool provided with a head pivotally attached to a handle. The head is movable between a rest position, in which the head is angularly displaced from the handle, and a biased position in which the head, handle, and a wiping blade are in linear relation. In the biased position, the wiping blade is maintained at an optimum angle for cleaning a glass surface even with the handle held generally perpendicular to the glass. A spring is fully contained in the head and biases the head toward the rest position. A tension adjustment knob in the head permits adjustment of the spring to a tension level according to the ergonomic requirements of a user. In a second embodiment of the invention an improved locking mechanism comprises a pivoting lock lever held against a top wall of a recess in the head of the squeegee by a retainer. The lock is movable between locked and released positions. In the locked position, stop surfaces on the lock lever abut with upward facing ledges of side plates on the forward portion of a main handle body to lock the head in the biased position. Two springs have forward projections which rest in downwardly biased engagement on a spring pull nut. The spring pull nut is adjustable by turning an adjustment knob to modify the tension on the springs.

The main disadvantage of the above disclosed spring-biased pivoting squeegee resides in its relative high complexity for this type of implements. Hence, it is difficult for this implement to preserve, with the minimum cost of operation, its operation capacity during the stipulated service life.

Another example is U.S. Pat. No. 5,930,863, granted Aug. 31, 1999 to Samuelsson for a “Quick release squeegee”. That patent discloses a squeegee comprising a squeegee body including a forwardly projecting stationary jaw device formed with a rearward portion, an intermediate portion, and a forward extremity configured with a first clamp element. A floating jaw co-extensive with the stationary jaw is formed with a rearward section, a medial section, and a forward end is formed with a second clamp element confronting the first clamp element. The floating jaw and the stationary jaw device cooperate to form a lever retraction cavity. The floating jaw is formed on one side of the cavity with an elongated notch. A fulcrum pin connects one of the portions to one of the sections to form a fulcrum linkage for pivoting of the floating jaw relative to the stationary jaw device from a release position to a clamping position. A lever mounted on one end to one of the sections other than the section forming the fulcrum linkage is received in the cavity and rotatable from a clamping position nested in the cavity outwardly through the notch to an extended release position. A cam section on one end of the lever is interposed between the stationary jaw device and floating jaw. When the lever is rotated from the clamping position to the release position, it rotates the second clamp element away from the first clamp element.

The above disclosed quick release squeegee constitutes a complicated implement incorporating many parts with special configurations. This raises the costs of manufacture which has a direct impact on the economic aspect of window cleaning operations. Moreover, reliability and service life are affected.

### II. SUMMARY OF THE INVENTION

In view of the above state of the art, the applicant concluded that there is a need for an improved implement for engaging planar surfaces while effecting translation movements on those surfaces.

The present invention is the result of years of observation and tests made by the applicant who is directly involved in the field of the invention.

Thus, a first objective of the present invention is to develop a versatile implement for engaging planar surfaces while effecting translation movements on those surfaces, which implement is adaptable to be used in combination with a variety of working tools that can be easily incorporated into or detach from the implement.

A second objective of the present invention is to develop a implement as the above one, wherein the angle between a working tool and its handle can be conveniently and rapidly adjusted to adequately perform the windows' cleaning or alike operations.

A third objective of the present invention is to develop a implement, as the previous ones, which provides enhanced reliability and extended service life.

Broadly stating, according to the present invention an implement for engaging planar surfaces while effecting translation movements on those surfaces, comprises an implement for engaging planar surfaces while effecting translation movements on those surfaces, comprising a head and a handle interconnected to the head. The head is provided with a projecting insertion element, which extends centrally and backwardly. The handle includes a front zone and a back zone; a longitudinal axis of said front zone intersects a longitudinal axis of the back zone. The front zone incorporates an internally engaging, frontally open channel, shaped to complementarily conform to the shape and size of the projection insertion element, so as to admit and snugly capture, with a light-press fit, the projection insertion element. The head is provided with a front end portion adapted to engage and detachably secure a working tool, such as, for example, a wiping blade for window cleaning or a paint brush.

In one aspect of the present invention, the projecting insertion element is formed by a truncated shaped segment, resulted from a cone having an apex removed by an intersecting plane, parallel to a base of the cone. The apex is replaced by a dome shaped segment having a lateral surface defined by an inclination equal to that of the truncated shaped segment. The internally engaging, frontally open channel incorporates a blind elongated hole having a shape adapted for engaging and snugly capturing the projection insertion element. The longitudinal axis X of the handle is bent approximately at midway of its length.

In another aspect of the present invention, the projecting insertion element is shaped as a splined shaft of conventional type that extends centrally and backwards from the head. The handle comprises a front zone and a back zone and there is an angle between longitudinal axis of front zone and longitudinal axis of back zone.

The front zone incorporates an internally engaging, frontally open elongated orifice, shaped to complementarily conform to the splined shaft and for admitting and capturing the latter with with a tight contact. The splined shaft and the internally engaging, frontally open elongated orifice are dimensioned and manufactured adequately with to allow an easy attachment and prevent an accidental detachment of splined shaft.

In yet another aspect of the present invention, the projecting insertion element is shaped as a cylindrical shaft that extends centrally and backwards from the head. The handle comprises a front zone and a back zone. There is an angle between the longitudinal axis of the front zone and the longitudinal axis of the back zone. The front zone incorporates an internally engaging, frontally open, elongated canal, cylindrically shaped to complementarily conform to the cylindrical shaft. A gap is provided between the internally engaging, frontally open, elongated canal and the cylindrical shaft.

Use is made of a locking mechanism which enables the cylindrical shaft to be immobilized in the handle.

Another aspect of the present invention resides in a use of a coupling interposed between the front zone and the back zone of the handle. Each of the two mentioned zones constitutes an elongated, separate component. Thus, there is no fixed, pre-established angle at an intersection of the longitudinal axis of the front zone with the longitudinal axis of the back zone. The coupling is used for adapting the handle to specific operational requirements, achievable by changing relative positions of the front and back zones, i.e. a fixed angle between the former and the latter is established.

The coupling is of twin disk type, which comprises one disk extending from the back of front zone and an opposed (mirror image) disk extending from the front of back zone. The internal surfaces of the disk and the opposed disk are provided with V-toothed projections alternating with grooves. The disk and the opposed disk are each centrally traversed by an opening. The resulted openings are coaxial.

A bolt and a nut are used to interlock the disk with the opposed disk in a convenient position, after V-toothed projections of one disk have already penetrated the facing grooves of the other disk.

Yet another aspect of the present invention resides in the use of a knuckle joint having a connecting pin perpendicular to the longitudinal axis of any head and pivotally joining a working tool with a front part of any head. Thus, the working tool is enabled to pivot in a plane tangent to a planar surface contacted by the working tool.

### III. BRIEF DESCRIPTION OF THE DRAWINGS

Although the characteristic features of the invention will be particularly pointed out in the claims, the invention itself and the manner in which it may be made and used may be better understood by referring to the following description and accompanying drawings. Like reference numerals refer to like parts throughout the several views of the drawings in which:

FIG. 1 (Prior Art) depicts a known and commonly used implement, belonging to the same category as the present invention;

FIG. 2 (Prior Art) is a vertical cross section extending along the longitudinal axis of symmetry of the handle illustrated in FIG. 1 and continuing along the adjacent head;

FIG. 3 (Prior Art) illustrates the implement shown in FIGS. 1 and 2 (Prior Art) when provided with a knuckle which interconnects a handle with a working tool, so that the latter can pivot with respect to the former, but is inseparable from it;

FIG. 4 is a front elevation view of a basic embodiment of the present invention, wherein the inventive concept—a head detachably interconnected with a handle—is shown;

FIG. 5 is a vertical cross section extending along the longitudinal axis of symmetry of the handle illustrated in FIG. 4 and continuing along the adjacent head; a projecting insertion element extends centrally and backwards from the head; the handle comprises a front zone incorporating an internally engaging, frontally open channel, exposed to the exterior and shaped to complementarily conform to the shape and size of the projecting insertion and for admitting and snugly capturing the latter with a light-press fit;

FIG. 6 is a perspective view of a head incorporating an insertion element having a shape of a truncated cone shaped segment, resulted from a cone having its apex removed by an intersecting plane, parallel to the base of the cone; the removed apex is replaced by a dome shaped segment having a lateral surface defined in general by the same inclination as that of the truncated cone shaped segment;

FIG. 7 is a front elevation view of the head with the projecting insertion element, shown in perspective in FIG. 6;

FIG. 8 is a vertical cross section extending along the longitudinal axis of symmetry of the insertion element, incorporated into the head and continuing along the head itself; the head incorporates a working tool and a blade;

FIG. 9 is a vertical cross section extending along the longitudinal axis of symmetry of a handle including an internally engaging, frontally open channel; the latter comprises a blind elongated hole having a shape adapted for engaging the projecting insertion element (illustrated in FIGS. 6, 7 and 8) and snugly capturing it with a light-press fit;

FIG. 10 is a perspective, exploded view of an embodiment of the present invention, wherein use is made of a projecting insertion element, shaped as a splined shaft of conventional type, which extends centrally and backwards from the head;

FIG. 11 is a vertical cross section extending along the longitudinal axis of symmetry of a handle that includes an internally engaging, frontally open channel; the latter comprises a blind elongated hole having a shape adapted for engaging the projecting insertion element/splined shaft/ (illustrated in FIG. 10) and snugly capturing it with a light-press fit;

FIG. 12 depicts a transversal cross section of the projection insertion element, shaped as a splined shaft (see FIG. 10);

FIG. 12 A depicts a transversal cross section of the internally engaging, frontally open channel adaptable for engaging the splined shaft shown in FIGS. 10 and 12;

FIG. 13 is perspective, exploded view of an embodiment of the present invention, wherein use is made of a projecting insertion element, shaped as a cylindrical shaft that extends centrally and backwards from a head;

FIG. 14 is a vertical cross section extending along the longitudinal axis of symmetry of the handle shown on FIG. 13; that handle includes an internally engaging, frontally open channel; the latter comprises a blind elongated hole having a shape of a hollow cylinder adapted for engaging the cylindrical projecting insertion element (illustrated in FIG. 13) and snugly capturing it with a light-press fit;

FIG. 15 is a longitudinal cross section taken along a connection of cylindrical shaft (see FIG. 13) inserted into blind elongated hole having the shape of a hollow cylinder; via a locking nut, the cylindrical shaft is immobilized in the hollow cylinder;

FIG. 16 illustrates a variant of the invention, applicable to all the foregoing embodiments; it resides in the use of a coupling interposed between a front zone and a back zone of a handle, each of the two mentioned zones constituting an elongated, separate component; no fixed, pre-established angle at an intersection of the longitudinal axis of the front zone with longitudinal axis of back zone; the coupling is used for adapting the handle to specific operational requirements, achievable by changing relative positions of front and back zones, i.e. a fixed angle between the former and the latter is established; and

FIG. 17 illustrates another variant of the invention, applicable to all the foregoing embodiments, without the previous variant or together with it; it resides in the use of a knuckle joint having a connecting pin perpendicular to the longitudinal axis of any aforementioned heads and pivotally joining a working tool with a front part of any head; thus, a working tool is enabled to pivot in a plane tangent to a planar surface contacted by working tool.

### IV. DESCRIPTION OF THE PREFERRED EMBODIMENTS

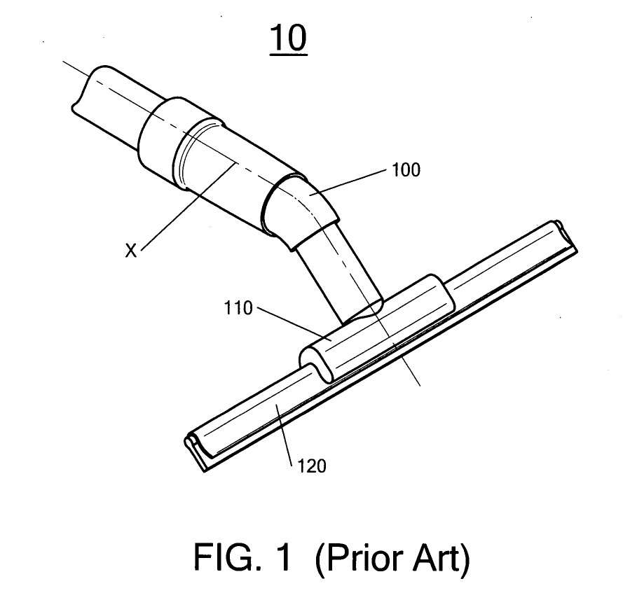

Referring to FIGS. 1, 2 and 3, there are shown two exemplary embodiments of the prior art, as largely known and used on the market, which embodiments, as the applicant considers, will emphasize the salient difference between his invention and the related state of the prior art.

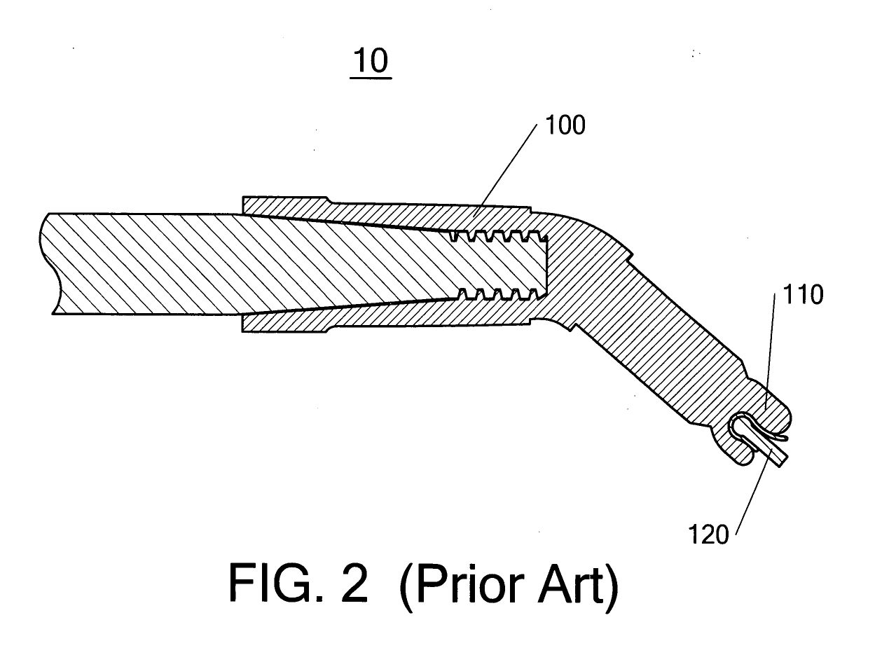

FIGS. 1 and 2 depict an implement. The implement, identified by reference number 10, comprises a handle 100 and a head 110 forwardly extending from handle 100. In the described and shown embodiment, handle 100 and head 110 form a unitary part. In the forthcoming embodiment, handle 100 and head 110 constitute distinct parts, pivotally, but not detachably interconnected.

A wiping blade 120 is transversely and detachably secured to a front end portion of handle 100.

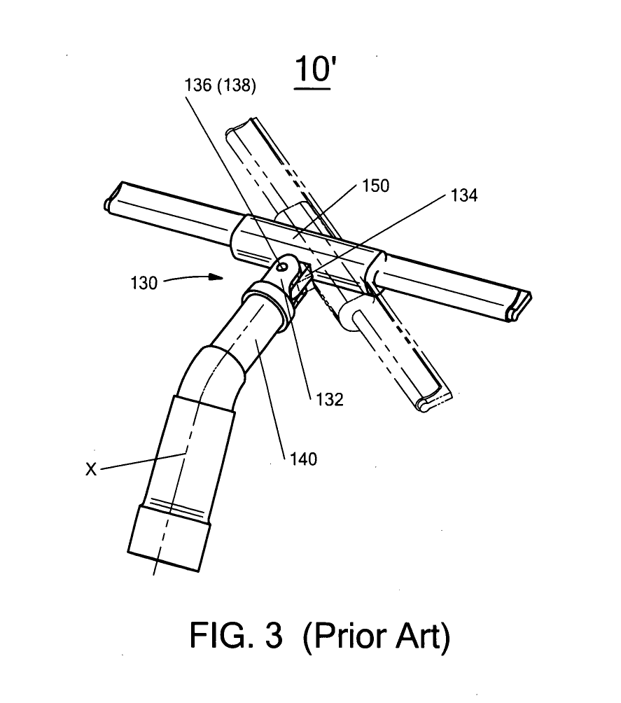

Referring to another prior art embodiment illustrated in FIG. 3, an implement 10′ incorporates a knuckle joint 130 having two parallel projections 132 secured to a front end of handle 140 and a flat jaw 134 intercalated between the two parallel projections 132 and secured to head 150. Each of the two parallel projections 132 and flat jaw 134 are traversed by an eye 136, the resulting eyes 136 being coaxial. A pin 138 perpendicular to longitudinal axis of symmetry of handle 140 is inserted throughout all eyes 136, thus allowing a head 150 to pivot in one plane only, the latter being parallel to planar surfaces contacted by wiping blade 120.

As shown in FIGS. 1 to 3, the longitudinal axis X of handle (100, 140) is bent approximately at midway of its length.

As can be seen from the above embodiments, handle (100, 140) is firmly or pivotally, but not detachably, connected to head (110,150). Thus, the former and the latter form an inseparable unit, employable only for one type of operation and size, for example window cleaning, paint etc.

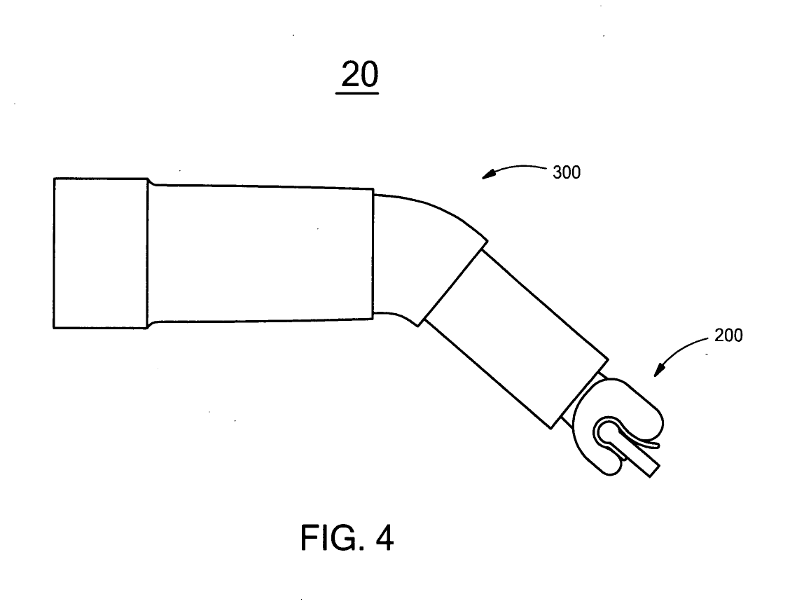

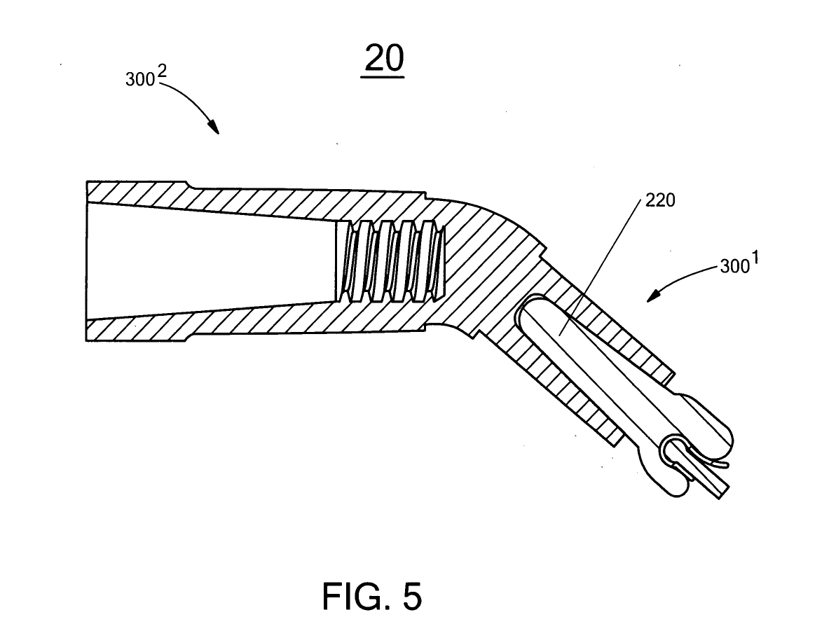

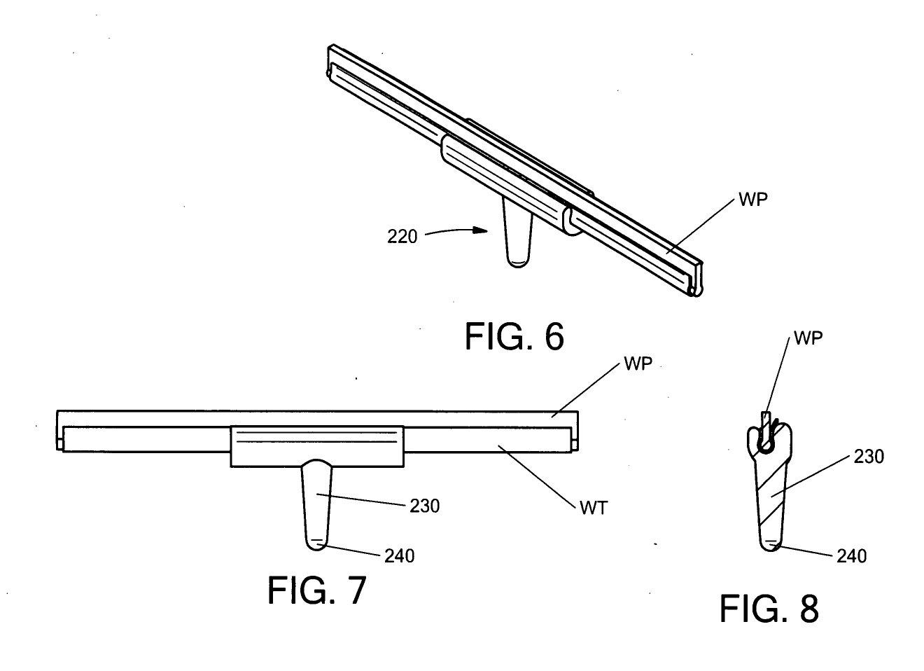

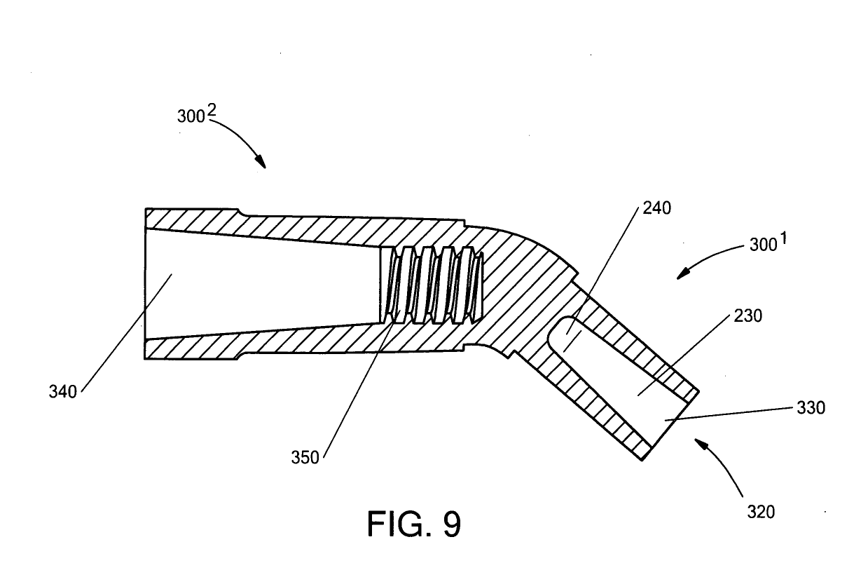

Broadly describing with reference to FIGS. 4 through 9, a first embodiment of the present invention concerning an implement for engaging planar surfaces while effecting translation movements on those surfaces, generally identified by reference number 20, comprises a head 200 detachably interconnected with a handle 300.

A projecting insertion element 220 extends centrally and backwards from head 200. Handle 300 comprises a front zone 300¹ and a back zone 300². Front zone 300¹ incorporates an internally engaging, frontally open channel 320, exposed to the exterior and shaped to complementarily conform to a shape and size of projecting insertion element 220 and for admitting and snugly capturing the latter with a light-press fit.

Head 200 extends, centrally and frontally, into a working tool WT. In the case of window cleaning, working tool WT is provided with a wiping blade WP which is detachably and transversally secured to a front end portion of working tool WT.

One can envisage the use of other working tools, such as, for example, a paint brush tool instead of depicted working tool WT with wiping blade WP. All of the working tools, intended to be used with the present implement for engaging planar surfaces while effecting translation movements on those surfaces, are, respectively, structurally integral with head 200. Thus, one handle 300 can be used with a variety of heads 200.

As can be seen from FIGS. 4 through 9, there is an angle between longitudinal axis (not shown) of front zone 300¹ and longitudinal axis (not shown) of back zone 300².

Describing now in detail the above broadly described first embodiment of the present invention, projecting insertion element 220 comprises a truncated cone shaped segment 230, resulted from a cone having its apex removed by an intersecting plane, parallel to the base of the cone. The removed apex is replaced by a dome shaped segment 240 having a lateral surface defined in general by the same inclination as that of the truncated cone shaped segment 230.

Internally engaging, frontally open channel 320 comprises a blind elongated hole 330 having a shape adapted for engaging projecting insertion element 220 and snugly capturing it with a light-press fit. As stated before, the latter comprises a hollow, truncated cone shaped segment 230 which extends into hollow, dome shaped segment 240.

Back zone 300² of handle 300 incorporates internally a blind opening 340 which terminates into a threaded portion 350. A handle extension pole (not shown) is adapted to be inserted into blind opening 340 and fastened to threaded portion 350.

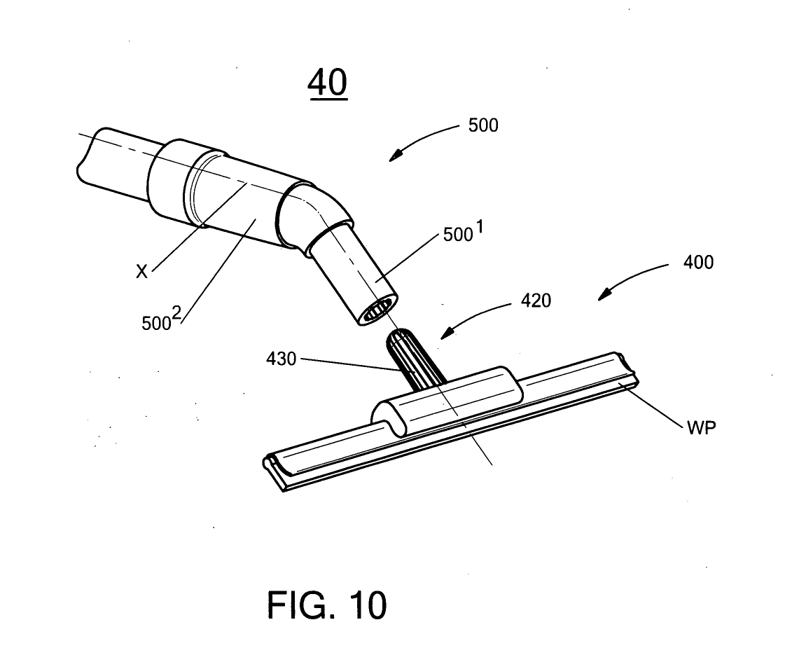

A second embodiment of an implement for engaging planar surfaces while effecting translation movements on those surfaces, described with reference to FIGS. 10 to 12A, generally identified by reference number 40, comprises a head 400 detachably interconnected with a handle 500. Head 400 and handle 500 constitute separate parts.

A wiping blade WP is detachably and transversally secured to a front end portion of head 400 via working tool WT.

A projecting insertion element 420, shaped as a splined shaft 430 of conventional type, extends centrally and backwards from head 400.

Handle 500 comprises a front zone 500¹ and a back zone 500².

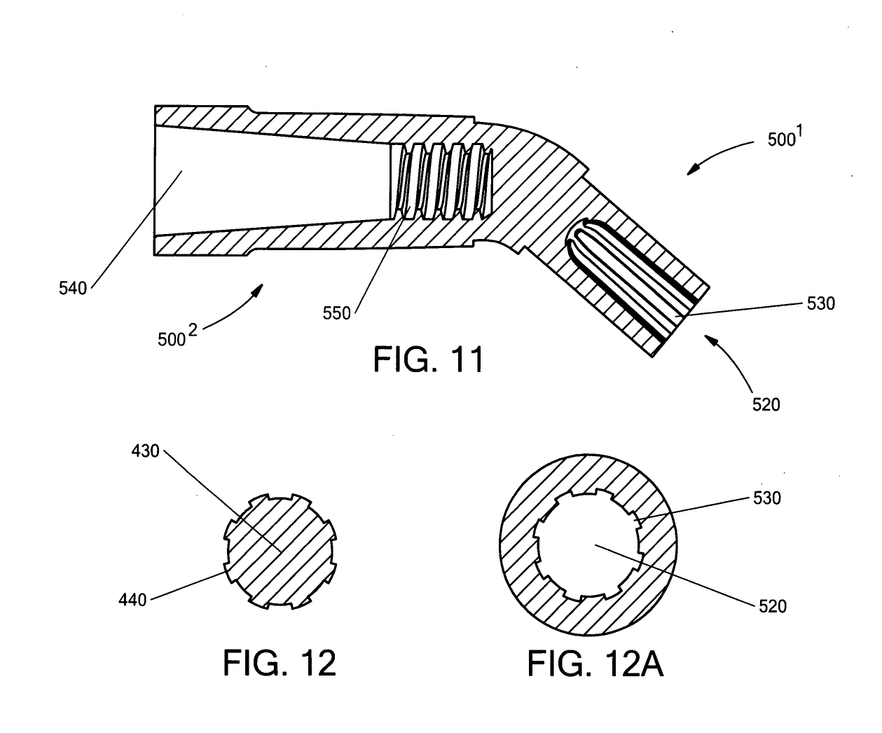

As can be seen from FIGS. 10 and 11, there is an angle between longitudinal axis of front zone 500¹ and longitudinal axis of back zone 500².

Front zone 500¹ incorporates an internally engaging, frontally open elongated orifice 520, shaped to complementarily conform to splined shaft 430 and for admitting and capturing the latter with a tight contact. Splined shaft 430 and internally engaging, frontally open elongated orifice 520 are adequately dimensioned and manufactured to allow an easy attachment and prevent an accidental detachment of splined shaft 430.

Splined shaft 430 is formed by projections 440 longitudinally extending and equally spaced circumferentially on it; internally engaging, frontally open elongated orifice 520 is formed by recesses 530, also equally spaced circumferentially on it.

As in the first disclosed embodiment, back zone 500² of handle 500 incorporates internally an elongated blind opening 540 which terminates into a threaded portion 550. A handle extension pole (not shown), provided with a threaded end, is adapted to be inserted into elongated blind opening 540 and fastened to its threaded portion 550.

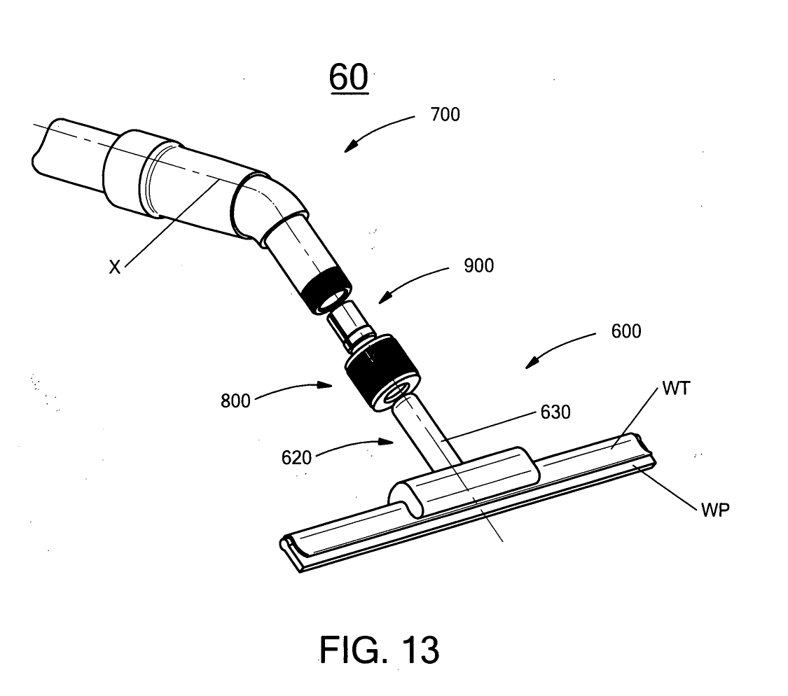

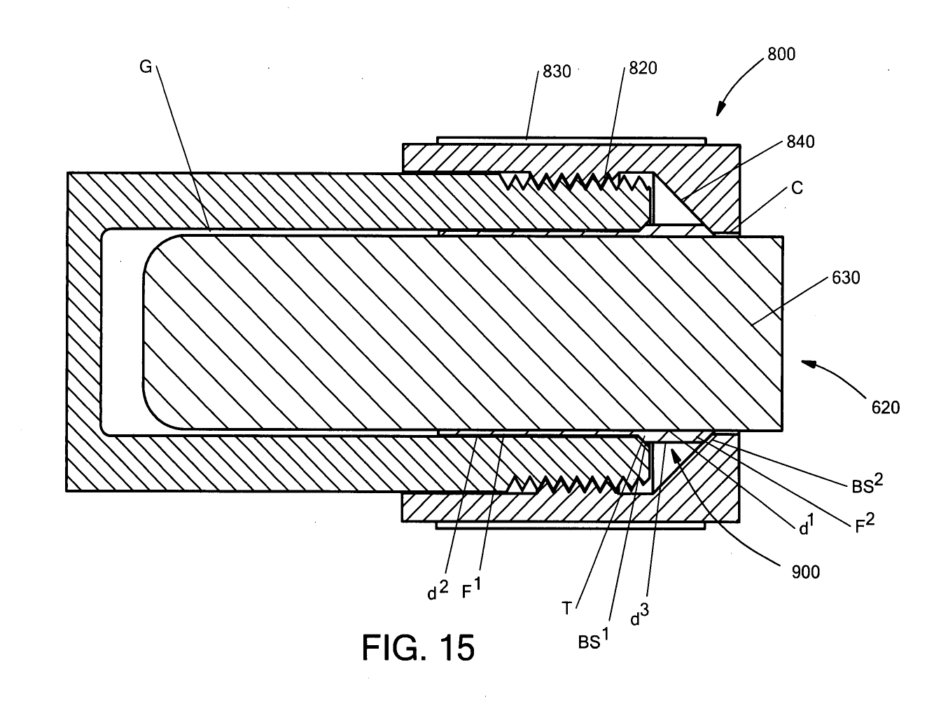

A third embodiment of an implement for engaging planar surfaces while effecting translation movements on those surfaces, described with reference to FIGS. 13 to 15, is generally identified by reference number 60, comprises a head 600 detachably interconnected with a handle 700. Head 600 and handle 700 constitute separate parts.

A wiping blade WP is detachably and transversally secured to a front end portion of head 600 via a working tool WT.

A projecting insertion element 620, shaped as a cylindrical shaft 630, extends centrally and backwards from head 600.

Handle 700 comprises a front zone 700¹ and a back zone 700².

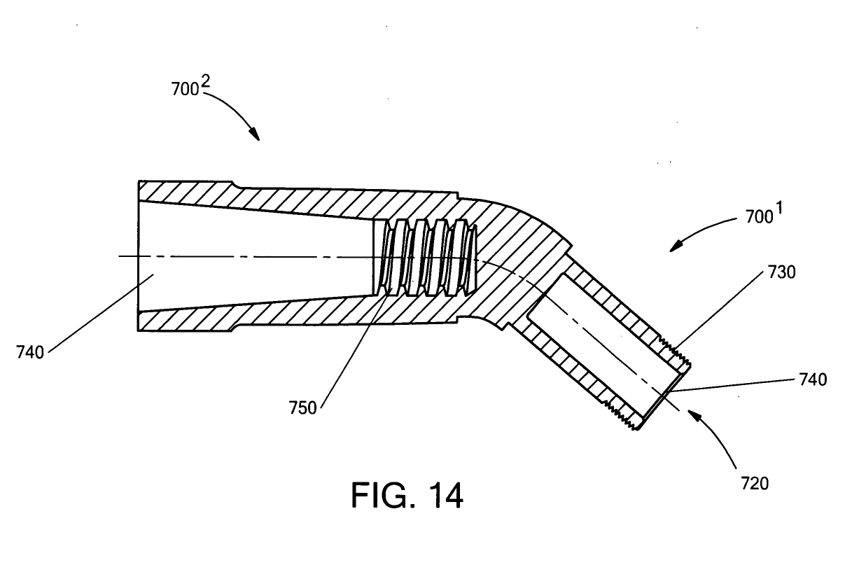

As can be seen from FIG. 14, there is an angle between longitudinal axis of front zone 700¹ and longitudinal axis of back zone 700².

Front zone 700¹ incorporates an internally engaging, frontally open, elongated canal 720, cylindrically shaped to complementarily conform to cylindrical shaft 630. A gap G is provided between internally engaging, frontally open, elongated canal 720 and cylindrical shaft 630. Front zone 700¹ is provided externally at its forward extremity with a threaded portion 730 and ends internally, at the same forward extremity, with a chamfered surface 740.

Use is made of a locking nut 800 provided internally with a threaded zone 820 and externally with serrations 830. Internally, at its end opposite its entrance, locking nut 800 terminates with a bevel contact surface 840. A clearance C is established between an innermost diameter of locking nut 800 and an outer diameter of projecting insertion element 620, shaped as a cylindrical shaft 630.

A plastic, split bushing 900 is close-fit mounted on cylindrical shaft 630. Plastic, split bushing 900 has one internal diameter d¹ corresponding to cylindrical shaft 630 and two external diameters d² and d³; d³ is relatively larger than d². A first segment F¹, delimited by internal diameter d¹ and external diameter d² is close-fit mounted on cylindrical shaft 630 and slidably inserted into internally engaging, frontally open, elongated canal 720. A second segment F², at a transition T from first segment F¹ to second segment F², is provided with a first tapped shoulder BS¹ held against chamfered surface 740, internally located at the forward extremity of front zone 700¹. Second segment F² incorporates oppositely first tapped shoulder BS¹ a second tapped shoulder BS² abutting against bevel contact surface 840.

When locking nut 800 is tightened on threaded portion 730, located at the forward extremity of front zone 700¹, plastic split bushing 900 is compressed against cylindrical shaft 630. Thus, cylindrical shaft 630 is immobilized in handle 700.

As in the first and second disclosed embodiments, back zone 700² of handle 700 incorporates internally an elongated blind opening 740 which terminates into a threaded portion 750. A handle extension pole (not shown), provided with a threaded end, is adapted to be inserted into elongated blind opening 740 and fastened to its threaded portion 750.

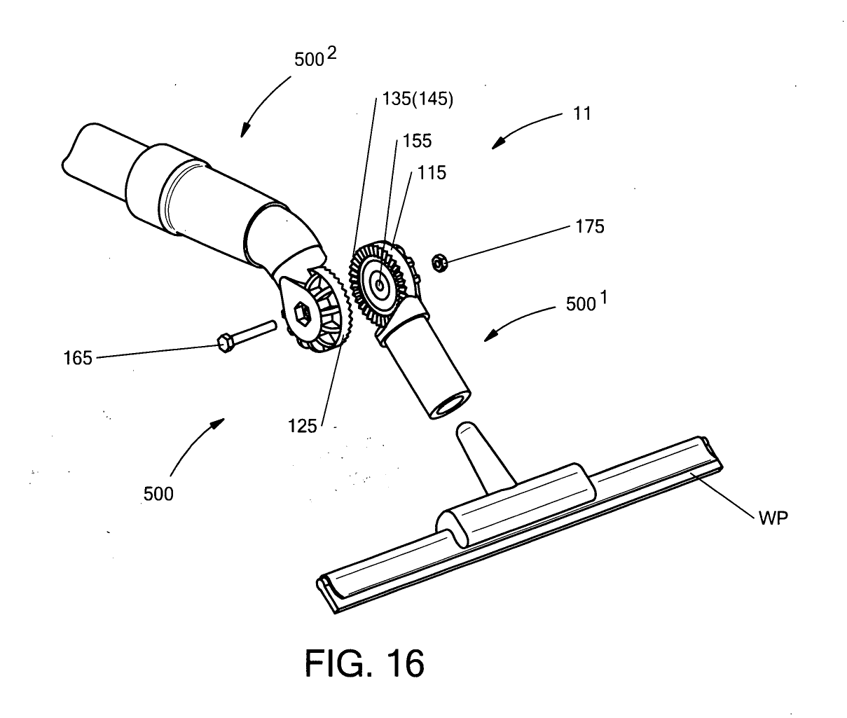

A variant (see FIG. 16) applicable to the above three embodiments is disclosed. An application used in combination with the first embodiment is considered exemplary for the other variants.

The variant resides in the use of a coupling 11 interposed between front zone 500¹ and back zone 500² of handle 500, each of the two mentioned zones constituting an elongated, separate component. Thus, there is no fixed, pre-established angle at an intersection of longitudinal axis (not shown) of front zone 500¹ with longitudinal (not shown) axis of back zone 500². Coupling 11 is used for adapting handle 500 to specific operational requirements, achievable by changing relative positions of front and back zones 500¹ and 500², i.e. a fixed angle between the former and the latter is established.

Coupling 11 is of twin disk type, comprising one disk 115 extending from the back of front zone 500¹ and an opposed (mirror image) disk 125 extending from the front of back zone 500². Internal surfaces of disk 115 and opposed disk 125 are provided with V-toothed projections 135 alternating with grooves 145. Disk 115 and opposed disk 125 are each centrally traversed by an opening 155. The resulted openings 155 are coaxial.

A bolt 165 and a nut 175 are used to interlock disk 115 with opposed disk 125 in a convenient position, after V-toothed projections 135 of one disk 115(125) have already penetrated facing grooves 145 of the other disk 125(115).

A second variant, first applicable to the three embodiments as initially disclosed and second applicable to the embodiments already incorporating the first variant is envisaged.

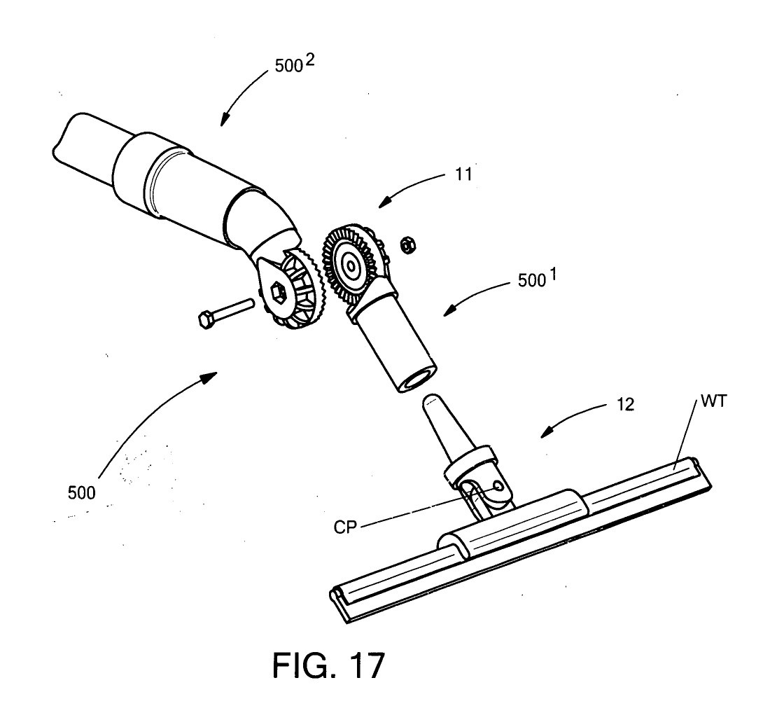

To exemplify the application of the second variant, the first embodiment incorporating both variants is depicted (see FIG. 17) and summarily disclosed in the forthcoming paragraph:

The variant resides in the use of a knuckle joint 12 having a connecting pin CP perpendicular to the longitudinal axis of any head 200, 400 or 600 and pivotally joining a working tool WT with a front part of any head 200, 400 or 600. Thus, working tool WT is enabled to pivot in a plane tangent to a planar surface contacted by working tool WT.

1. An implement for engaging planar surfaces while effecting translation movements on those surfaces, comprising
a head; and
a handle interconnected to said head;
said head being provided with
a projecting insertion element extending centrally and backwardly;
said handle including
a front zone and a back zone, a longitudinal axis of said front zone intersecting a longitudinal axis of said back zone, said front zone incorporating an internally engaging, frontally open channel, shaped to complementarily conform to a shape and a size of said projection insertion element, so as to admit and snugly capture, with a light-press fit, said projection insertion element;
said head being provided with a front end portion adapted to engage and detachably secure a working tool, such as, for example, a wiping blade for window cleaning or a paint brush.

2. The implement for engaging planar surfaces while effecting translation movements on those surfaces, as defined in claim 1.

3. The implement for engaging planar surfaces while effecting translation movements on those surfaces, as defined in claim 1, wherein said projecting insertion element extending centrally and backwardly is a splined shaft and wherein said internally engaging, frontally open channel incorporates a blind elongated hole shaped to complementarily conform to said splined shaft and for admitting and snugly capturing said splined shaft with a tight contact.

4. The implement for engaging planar surfaces while effecting translation movements on those surfaces, as defined in claim 1.

5. The implement as in any one of claims 1 and 3, further comprising a coupling interposed between a front zone and back zone of said handle, each of said front and back zones constituting an elongated, separate component, no fixed angle at an intersection of said longitudinal axis of said front zone and said longitudinal axis of said back zone being provided, said coupling being used for adapting said handle to specific operational requirements, achievable by changing a relative positions of said longitudinal axis of said front zone and said longitudinal axis of said back zone, so that a desired angle between said front and said back zones is conveniently chosen; said coupling being of twin disk type comprises one disk extending from a back of said front zone and an opposed (mirror image) disk extending from a front of said back zone, internal surfaces of said disk and of said opposed disk being provided with V-toothed projections alternating with grooves; said disk and said opposed disk being centrally traversed by an opening, a bolt and a nut being used to interlock said disk with said opposed disk, after said V-toothed projections of said disk have already penetrated said grooves of said other disk.

6. The implement as in any one of claims 1 and 3, further comprising a knuckle joint for pivotally joining said working tool with a frontal part of said head, said knuckle joint including a connecting pin perpendicular to said longitudinal axis of said head, so that said working tool is enabled, during use, to pivot in a plane tangent to a planar surface contacted by said working tool.
